(19) United States
(12) Patent Application Publication
(10) Pub. No.: US 2009/0103217 A1
(43) Pub. Date: Apr. 23, 2009

(54) SYSTEM AND APPARATUS FOR LIMITING CURRENT IN A SUPERCONDUCTING COIL

(75) Inventors: Anthony V. Langtry, Oxford (GB); Timothy J. Hollis, Bicester (GB)

Correspondence Address: PETER VOGEL;GE HEALTHCARE, 20225 WATER TOWER BLVD., MAIL STOP W492, BROOKFIELD, WI, 53045, US

(73) Assignee: General Electric Company, Schenectady, NY (US)

(21) Appl. No.: 11/873,720

(22) Filed: Oct. 17, 2007

(51) Int. Cl. H02H 9/02

(52) U.S. Cl. 361/19

(57) ABSTRACT

A superconducting coil circuit for a superconducting magnet includes a superconducting coil and a current limiting apparatus. The current limiting apparatus is connected in series with the superconducting coil and includes a mechanical device configured to cause a quench in the superconducting coil when a current in the superconducting coil reaches a predetermined value.

### FIELD OF THE INVENTION

The present invention relates generally to superconducting magnets and in particular to a system and apparatus for limiting current in a superconducting coil of a superconducting magnet.

### BACKGROUND OF THE INVENTION

Superconducting magnets may be used in a variety of applications including, but not limited to, magnetic resonance imaging (MRI) systems, nuclear magnetic resonance (NMR) systems used in chemistry, particle accelerators, mass spectrometers, and superconductive rotors for electric generators and motors. A superconducting magnet may include, for example, several radially aligned and longitudinally spaced apart superconductive coils. The superconductive coils are designed to create a magnetic field and are typically enclosed in a cryogenic environment designed to maintain the temperature of the superconducting coils below the appropriate critical temperature so that the superconducting coils are in a superconducting state with zero resistance. A magnet can be made superconductive by placing it in an extremely cold environment, such as by enclosing it in a cryostat or pressure vessel containing a cryogen, such as helium. The main superconducting magnet coils may be complemented with other superconducting “secondary coils” housed in the magnet cryogenic environment. For example, a superconducting magnet for an MRI system may include secondary coils such as shim coils, external disturbance shielding coils or drift compensation coils. Superconducting shim coils are used to compensate for or remove inhomogeneities from the magnetic field, B₀. Superconducting shielding coils are configured to carry currents in the direction opposite to the direction of the currents being carried by the main coils to cancel the stray magnetic field outside the magnet. A current is passed through the secondary coils to generate a field. Once the current in the superconducting secondary coils are adjusted to a proper value, the current is fixed and the superconducting coils operate in a persistent mode. Typically, superconducting secondary coils carry a small current during normal operation and are wound with a small wire that allows a high current density.

During operation of the superconducting magnet, various conditions may induce large or excessive currents in the main or secondary superconducting coils. Excessive or increased currents may cause large forces and damage the superconducting coils. In one example, in an MRI system in which the superconducting magnet has main and secondary superconducting coils, a loss of superconducting operation (or “quench”) of the main superconducting coils can induce current in the secondary superconducting coils. During a quench, a portion or portions of the superconducting magnet coils become resistive as a result of, for example, heating of a portion of the coils. The current in the superconducting magnet coils decays and the electromagnetic energy of the magnet is converted into thermal energy. Quenching can produce temperatures and voltages that can damage the magnet. Typically, superconducting magnets are designed with quench protection that, for example, causes the remainder of the main magnet coil to become resistive as soon as possible. For example, the main magnet coil circuit may be subdivided into multiple resistor-protected loops.

The superconducting secondary coils are mutually inductively coupled with the superconducting main coils. During a quench of the main magnet coil, a current is induced in the secondary coils due to the mutual inductance between the main magnet coil and the secondary coils. The secondary coils may be damaged if a large (or excessive) current is induced and accumulates in the secondary coils. Several solutions have been developed to protect superconducting secondary coils during a main magnet coil quench. In one solution, for a main magnet coil circuit that is wired as a single loop, the shim coil geometry is optimized to decouple the shim coil from the main magnet coil. In another solution, quench heaters are connected to the shim coils and the quench heaters are driven by the high voltages across the main coils of the quenching magnet. This solution requires extensive wiring between the main coil and the shim coil. In yet another solution, for a main magnet coil circuit subdivided into multiple protected loops, the mutual inductance between the shim coil and each loop of the main magnet coil is simultaneously minimized. This dynamically de-coupled shim solution requires an elaborate coil geometry and additional wire length.

It would be desirable to provide an apparatus and method for limiting the current induced in a superconducting coil that is self-contained and is triggered by the current in the superconducting coil. It would also be desirable to provide a current limiting device or apparatus that limits the current in a secondary superconducting coil without requiring additional wiring between a main superconducting coil and the secondary coil or dependence on the characteristics of the main coil.

### BRIEF DESCRIPTION OF THE INVENTION

In accordance with an embodiment, an apparatus for controlling current in a superconducting coil in a superconducting magnet assembly includes at least one limiter coil connected in series with the superconducting coil, a mechanical device positioned near the at least one limiter coil and a heater connected in parallel with the at least one limiter coil.

In accordance with another embodiment, a superconducting coil circuit for a superconducting magnet includes a superconducting coil and a current limiting apparatus connected in series with the superconducting coil, the current limiting apparatus comprising a mechanical device configured to cause a quench in the superconducting coil when a current in the superconducting coil reaches a predetermined value.

### BRIEF DESCRIPTION OF THE DRAWINGS

The invention will become more fully understood from the following detailed description, taken in conjunction with the accompanying drawings, wherein like reference numerals refer to like parts, in which:

FIG. 1 is a simplified schematic diagram of a cross-section of a superconducting magnet assembly showing relative positions of various elements in accordance with an embodiment;

FIG. 2 is a simplified schematic diagram of a cross-section of a MRI magnet assembly showing relative positions of various elements in accordance with an embodiment;

FIG. 3 is a schematic diagram of a superconducting coil circuit including an apparatus for limiting the current in a superconducting coil in accordance with an embodiment; and

FIG. 4 is a schematic diagram of a superconducting coil circuit including an apparatus for limiting the current in a superconducting coil in accordance with an alternative embodiment.

### DETAILED DESCRIPTION

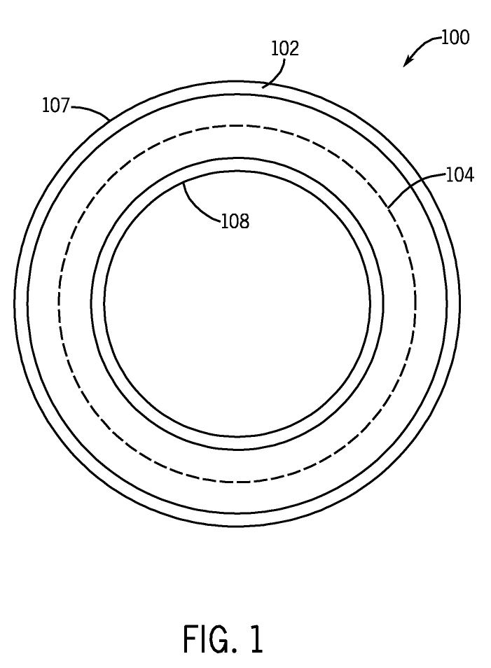

FIG. 1 is a simplified schematic diagram of a cross-section of a superconducting magnet assembly showing relative positions of various elements in accordance with an embodiment. Superconducting magnet 100 is cylindrical and annular in shape, however, it should be understood that a superconducting magnet may have an alternative shape or configuration. Superconducting magnet 100 includes, among other elements, a cryostat 102 and superconductive main magnet coils 104 housed within the cryostat 102. Various other elements, such as supports, suspension members, end caps, brackets, etc. are omitted from FIG. 1 for clarity. The main magnet coils 104 are designed to generate a magnetic field. Cryostat 102 has an outer surface 107 and an inner surface 108 and is designed to maintain a cryogenic environment designed to maintain the temperature of the main magnet coils 104 below a critical temperature so that the main magnet coils 104 are in a superconducting state with zero resistance.

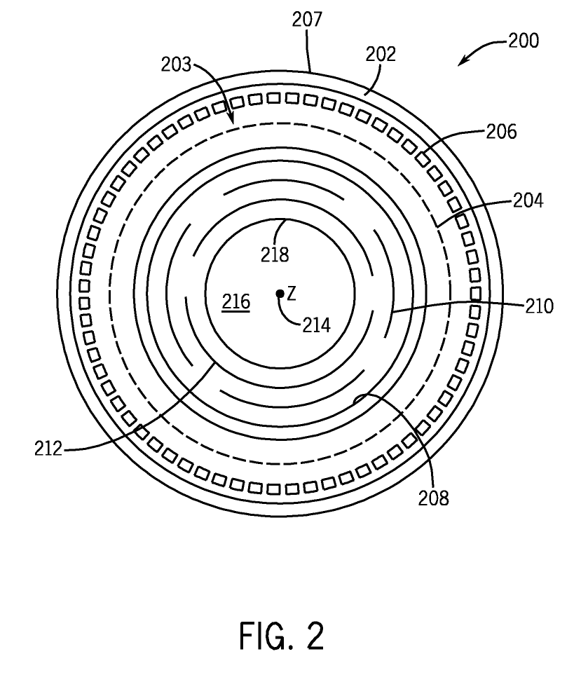

A superconducting magnet (for example, an MRI superconducting magnet) may also include secondary superconducting coils. FIG. 2 is a simplified schematic diagram of a cross-section of a MRI magnet assembly showing relative positions of various elements in accordance with an embodiment. Magnet assembly 200 is cylindrical and annular in shape. While the following describes a cylindrical MRI magnet assembly topology, it should be understood that other magnet assembly topologies may utilize embodiments of the invention described herein. Magnet assembly 200 includes, among other elements, a superconducting magnet 203, a gradient coil assembly 210 and an RF coil or coils 212. Various other elements, such as supports, suspension members, end caps, brackets, etc. are omitted from FIG. 2 for clarity. Superconducting magnet 203 is housed in a cryostat 202 having an outer surface 207 and an inner surface (or warm bore) 208. A cylindrical patient volume or space 216 is surrounded by a patient bore tube 218. RF coil 212 is mounted on an outer surface of the patient bore tube 218 and mounted inside the gradient coil assembly 210. The gradient coil assembly 210 is disposed around the RF coil 212 in a spaced-apart coaxial relationship and the gradient coil assembly 210 circumferentially surrounds the RF coil 212. Gradient coil assembly 210 is circumferentially surrounded by magnet 203 and cryostat 202.

A patient or imaging subject may be inserted into the magnet assembly 200 along a center axis 214 (e.g., a z-axis) on a patient table or cradle (not shown). Center axis 214 is aligned along the tube axis of the magnet assembly 200 parallel to the direction of a main magnetic field, B₀, generated by the magnet 203. RF coil 212 may be used to apply a radio frequency pulse (or a plurality of pulses) to a patient or subject and may be used to receive MR information back from the subject. Gradient coil assembly 210 generates time dependent gradient magnetic pulses that are used to spatially encode points in the imaging volume 216.

Superconducting magnet 203 includes superconductive main magnet coils 204 and superconductive secondary coils 206 (for example, superconductive shim coils, external disturbance shielding coils or drift compensation coils). The main magnet coils 204 are designed to create a main magnetic field, B₀, of high uniformity within the patient volume 216. In an embodiment where the secondary coils 206 are shim coils, the shim coils are used to compensate for inhomogeneities in the main magnetic field. In an embodiment where the secondary coils 206 are shielding coils, the shielding coils are used to cancel the stray magnetic field outside the magnet. Superconducting magnet 203 is enclosed in a cryogenic environment designed to maintain the temperature of the main magnet coils 204 and the secondary coils 206 below the appropriate critical temperature so that the main coils 204 and secondary coils 206 are in a superconducting state with zero resistance. Cryostat 202 houses and encloses the main coils 204 and secondary coils 206 and is configured to maintain the cryogenic environment.

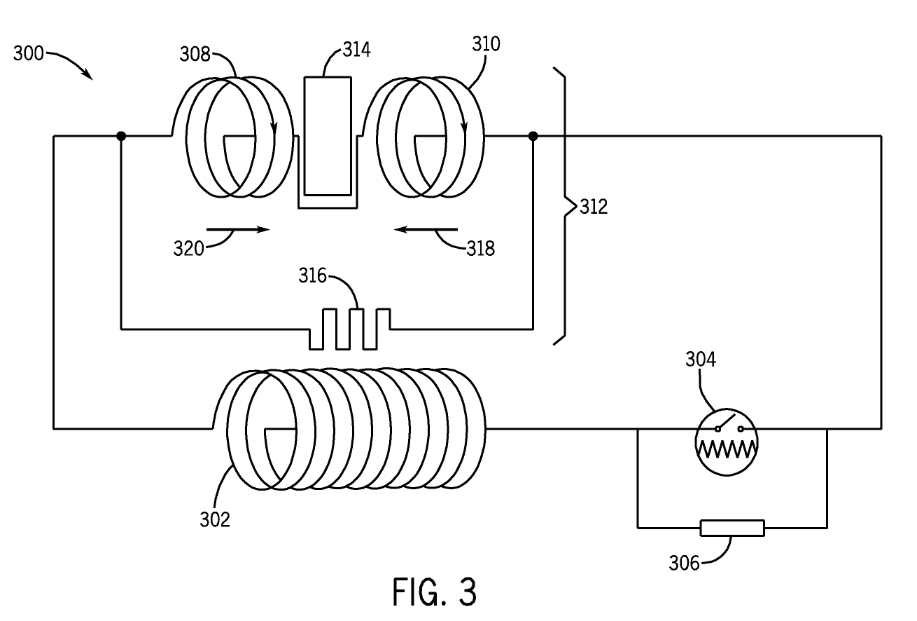

Referring to both FIGS. 1 and 2, various conditions may induce large or excessive currents in the main 104, 204 or secondary 206 superconducting coils. For example, current may be induced in the secondary coils 206 during a quench of the main magnet coils 204. A current limiting device or apparatus may be used to prevent an excessive current accumulation in the main 104, 204 or secondary coils 206. FIG. 3 is a schematic diagram of a superconducting coil circuit including an apparatus for limiting the current in a superconducting coil in accordance with an embodiment. The superconducting coil circuit 300 is compatible with the above described superconducting magnets of FIGS. 1 and 2 or any similar or equivalent superconducting magnet. The superconducting coil circuit 300 includes a superconducting coil 302, a superconducting switch 304, a switch protection resistor 306 and a current limiting apparatus 312. Superconducting coil 302 may be, for example, a main superconducting magnet coil or a secondary superconducting magnet coil such as a shim coil, an external disturbance shielding coil or a drift compensation coil. Current limiting apparatus 312 includes a pair of mechanically coupled coils (a first limiter coil 308 and a second limiter coil 310) that are in close proximity to each other and mechanically separated from each other by a mechanical device 314 with non-linear force displacement characteristics. Mechanical devices with non-linear force displacement characteristics include, but are not limited to, a disk spring (in “snap through” mode), a columnar spring (in “buckling” mode) and a frictional device (using the difference between static and kinetic friction) in conjunction with a return spring. The first limiter coil 308 and the second limiter coil 310 are superconducting and are wired in series with the secondary coil 302. The current limiting apparatus also includes a heater 316 that is connected in parallel with the first limiter coil 308 and the second limiter coil 310. The current limiting apparatus 312 is configured to limit the current accumulation in the superconducting coil 302 and is triggered based on a predetermined value of current in the superconducting coil 302.

As mentioned, various conditions may result in current being induced (or increasing) in the superconducting coil 302. For example, during a quench in a superconducting main magnet coil (204, shown in FIG. 2), current is induced in the superconducting secondary coil (206, shown in FIG. 2). As the current in the superconducting coil 302 increases, an attractive force between the first limiter coil 308 and the second limiter coil 310 increases. The attractive force between the first limiter coil 308 and the second limiter coil 310 increases until the current in the superconducting coil 302 reaches a predetermined value at which the force-displacement relationship of the mechanical device 314 reaches a predetermined point at which the stiffness of the mechanical device 314 is reduced and allows the first limiter coil 308 and the second limiter coil 310 to move towards each other (illustrated by arrows 318 and 320). The first limiter coil 308 and the second limiter coil 310 move towards each other until movement is arrested by a stop, i.e., the mechanical device 314. When the movement of the pair of limiter coils is arrested, the energy of the first limiter coil 308 and the second limiter coil 310 is realized as heat. The heat is communicated to the first limiter coil 308 and the second limiter coil 310 and causes the first and second limiter coils 308, 310 to quench and become normal, i.e., become resistive. The first limiter coil 308 and the second limiter coil 310 are composed of and wound with superconducting wire characterized by a higher resistance in its normal (non-superconducting) state and by having a lower resistance to quenching. For example, the superconducting wire may be composed of and wound with superconducting wire stabilized by a Cupro-Nickel (Cu—Ni) matrix.

Once the limiter coils 308, 310 become normal, the resistance of the limiter coils 308, 310 increases and current will flow through a lower resistance path through the heater 316 parallel to the limiter coils 308, 310. Heater 316 prevents the limiter coils 308, 310 from experiencing excessive heating. In addition, the heater 316 dissipates heat that heats the superconducting coil 302 so that a quench propagates through the superconducting coil 302 and the superconducting coil 302 becomes resistive. The increased resistance of the superconducting coil 302 limits the current accumulation in the superconducting coil 302.

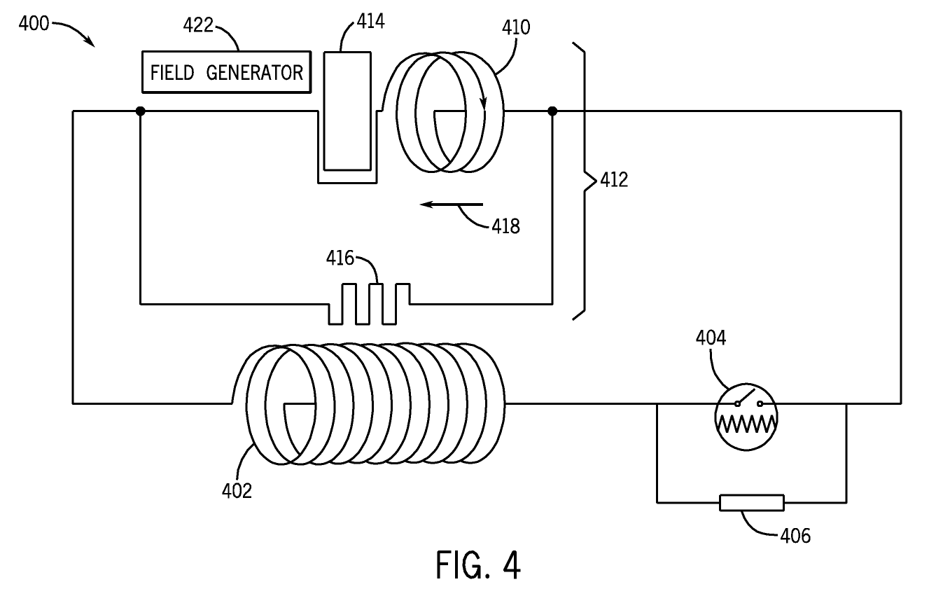

FIG. 4 is a schematic diagram of a superconducting coil circuit including an apparatus for limiting the current in a superconducting coil in accordance with an alternative embodiment. The superconducting coil circuit 400 includes a superconducting coil 402, a superconducting switch 404, a switch protection resistor 406 and a current limiting apparatus 412. The superconducting coil circuit 400 is compatible with the above-described superconducting magnets of FIGS. 1 and 2 or any similar or equivalent superconducting magnet. As mentioned, the superconducting coil 402 may be, for example, a main superconducting magnet coil or a secondary superconducting magnet coil. Current limiting apparatus 412 includes a limiter coil 410 and a mechanical device 414 with non-linear force displacement characteristics positioned in proximity to the limiter coil 410. Limiter coil 410 is superconducting and wired in series with the superconducting coil 402. As mentioned, limiter coil 410 is composed of and wound with superconducting wire characterized by a higher resistance in its normal (non-superconducting) state and by having a lower resistance to quenching. The current limiting apparatus 412 also includes a heater 416 that is connected in parallel with the limiter coil 410. A field generator 422 is located in proximity to the mechanical device 414 and the limiter coil 410. The field generator 422 generates a magnetic field in the vicinity of the limiter coil 410 to which the limiter coil 410 is attracted. In one embodiment, the field generator 422 is a permanent or superconducting magnet. In an alternative embodiment, for superconducting applications that do not use a strong background magnetic field, the field generator 422 may be a piece of ferromagnetic material.

The current limiting apparatus 412 is configured to limit the current accumulation in the superconducting coil 402 and is triggered based on a predetermined value of current in the superconducting coil 402. When the current in the superconducting coil 402 increases, an attractive force between the limiter coil 410 and the field generated by field generator 422 increases. The attractive force between the limiter coil 410 and the field generated by field generator 422 increases until the current in the superconducting coil 402 reaches a predetermined value at which the force-displacement relationship of the mechanical device 414 reaches a predetermined point at which the stiffness of the mechanical device 414 is reduced and allows the limiter coil 410 to move towards the field generator 422 (illustrated by arrow 418). The limiter coil 410 moves towards the field generator 422 until movement is arrested by a stop, i.e., the mechanical device 414. When the movement of the limiter coil 410 is arrested, the energy of the limiter coil 410 is realized as heat. The heat is transferred to the limiter coil 410 and causes the limiter coil 410 to quench and become normal, i.e., become resistive. Once the limiter coil 410 becomes normal, the resistance of the limiter coil 410 increases and current will flow through a lower resistance path through the heater 416 parallel to the limiter coil 410. In addition, the heater 416 dissipates heat that heats the superconducting coil 402 so that a quench propagates through the superconducting coil 40 and the superconducting coil 402 becomes resistive. The increased resistance of the superconducting coil 402 limits the current accumulation in the superconducting coil 402.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. The order and sequence of any process or method steps may be varied or re-sequenced according to alternative embodiments.

Many other changes and modifications may be made to the present invention without departing from the spirit thereof. The scope of these and other changes will become apparent from the appended claims.

What is claimed is:

1. An apparatus for controlling current in a superconducting coil in a superconducting magnet assembly, the apparatus comprising:
at least one limiter coil connected in series with the superconducting coil;
a mechanical device positioned near the at least one limiter coil; and
a heater connected in parallel with the at least one limiter coil.

2. An apparatus according to claim 1, wherein the at least one limiter coil comprises a first limiter coil and a second limiter coil connected in series with the first limiter coil and the superconducting coil.

3. An apparatus according to claim 2, wherein the mechanical device is positioned between the first limiter coil and the second limiter coil.

4. An apparatus according to claim 1, wherein the superconducting coil is a main superconducting coil.

5. An apparatus according to claim 1, wherein the superconducting coil is a secondary superconducting coil.

6. An apparatus according to claim 5, wherein the secondary superconducting coil is a shim coil.

7. An apparatus according to claim 5, wherein the secondary superconducting coil is an external disturbance shielding coil.

8. An apparatus according to claim 5, wherein the secondary superconducting coil is a drift compensation coil.

9. An apparatus according to claim 1, wherein the mechanical device has a non-linear force displacement characteristic.

10. An apparatus according to claim 1, wherein the at least one limiter coil comprises a single limiter coil positioned in proximity to the mechanical device, wherein the limiter coil is configured to move towards the mechanical device in response to an attractive force caused by a magnetic field.

11. An apparatus according to claim 10, wherein the magnetic field is generated by a piece of ferromagnetic material.

12. An apparatus according to claim 10, wherein the magnetic field is generated by a magnet.

13. A superconducting coil circuit for a superconducting magnet, the superconducting coil circuit comprising:
a superconducting coil; and
a current limiting apparatus connected in series with the superconducting coil, the current limiting apparatus comprising a mechanical device configured to cause a quench in the superconducting coil when a current in the superconducting coil reaches a predetermined value.

14. A superconducting coil circuit according to claim 13, wherein the superconducting coil is a main superconducting coil.

15. A superconducting coil circuit according to claim 13, wherein the superconducting coil is a secondary superconducting coil.

16. A superconducting coil circuit according to claim 15, wherein the superconducting secondary coil is a shim coil.

17. A superconducting coil circuit according to claim 15, wherein the superconducting secondary coil is an external disturbance shielding coil.

18. A superconducting coil circuit according to claim 15, wherein the superconducting secondary coil is a drift compensation coil.

19. A superconducting coil circuit according to claim 13, wherein the current limiting apparatus further comprises:
a first limiter coil connected in series with the superconducting coil;
a second limiter coil connected in series with the first limiter coil and the superconducting coil; and
a heater connected in parallel with the first limiter coil and the second limiter coil;
wherein the mechanical device is positioned between the first limiter coil and the second limiter coil.

20. A superconducting coil circuit according to claim 13, wherein the mechanical device has a non-linear force displacement characteristic.

21. A superconducting coil circuit according to claim 13, wherein the current limiting apparatus further comprises:
a limiter coil connected in series with the superconducting coil and positioned in proximity to the mechanical device;
wherein the limiter coil is configured to move towards the mechanical device in response to an attractive force caused by a magnetic field.

22. A superconducting coil circuit according to claim 21, wherein the magnetic field is generated by a piece of ferromagnetic material.

23. A superconducting coil according to claim 21, wherein the magnetic field is generated by a magnet.
